(19) United States
(12) Patent Application Publication
(10) Pub. No.: US 2010/0159081 A1
(43) Pub. Date: Jun. 24, 2010

(54) Ice Cream Sundae

(75) Inventors: Peter Hardie Lind, Montpelier, VT (US); Peter George Gosselin, Richmond, VT (US)

Correspondence Address: UNILEVER PATENT GROUP, 800 SYLVAN AVENUE, AG West S. Wing, ENGLEWOOD CLIFFS, NJ, 07632-3100, US

(73) Assignee: B & J Homemade, Inc., South Burlington, VT (US)

(21) Appl. No.: 12/342,671

(22) Filed: Dec. 23, 2008

(51) Int. Cl. A23G 9/00; A23G 9/48; A23G 9/22; A23G 9/28

(52) U.S. Cl. 426/90; 426/101

(57) ABSTRACT

An ice cream sundae or other frozen confection sundae in a cup. The cup is intended to be inverted before serving so the sauce topping for the sundae, such as chocolate fudge, butterscotch or caramel, is disposed toward the bottom of the container, beneath the frozen confection. A release agent is interposed between the sauce topping and the container. It has been found that use of a coating release agent permits a very clean release of the chocolate fudge or other topping from the sides and bottom of the container.

### BACKGROUND OF THE INVENTION

Frozen confections are an indulgence appreciated by many consumers. They have been enjoyed in many forms, but one form which is a special favorite is the ice cream sundae. Traditionally, ice cream sundaes have been prepared for immediate consumption after sale. Traditional venues have included ice cream shops and restaurants.

Not all consumers wish to visit an ice cream shop or restaurant every time they want to have an ice cream sundae. In addition, many fast food restaurants would prefer to make the process of ice cream sundae preparation as simple as possible to conserve time and resources. For instance, many restaurants would prefer that the ice cream and the toppings be present in one unit which merely needs to be removed from its container, rather than requiring steps of scooping ice cream, and pouring a topping such as fudge or caramel sauce onto the ice cream to create the sundae.

Some previous efforts at developing an ice cream sundae which can be removed from a container as a whole, rather than requiring separate dispensing of the topping onto the confection, have fallen short of some consumer expectations. Prior prepackaged ice cream sundaes have tended to suffer from the disadvantage that the topping does not completely release from the container so that a portion of the topping is visibly missing from the confection. The result is that the consumer or other person preparing the sundae must either spoon part of the sundae from the container onto the frozen confection, which still may not appear to be a normal sundae, or the consumer will be missing a portion of his or her treat.

A product by the name of “Friazzo” was sold in the United States prior to the present invention. It is an ice cream sundae sold in a cup in restaurants. The cup is inverted after its top cover has been removed and the sundae is pushed out through the cup opening by pressure exerted on the bottom of the container. A crumb layer comprising particulates like crushed nuts or cookies is used as an aid to release product from the cup. The product has a thin fudge layer under the crumb layer.

Friendly's restaurants sell a “Friendly To Go” sundae which is eaten in the cup.

Carte D'Or is a sundae which is dispensed by inverting the container and squeezing the sundae onto a plate.

Chocolate confection coatings have been used commercially in the U.S. prior to the present invention as a spray on the inside of cones to help prevent moisture migration from the ice cream into the cone. Without this, chocolate coating the cone would become soggy.

Stover, U.S. Pat. No. 2,005,245 is directed to a packaged ice cream sundae said to be adapted to be taken to the home and ejected from the container to form an Ice cream sundae. The invention contemplates use of a receptacle having a removable top and a movable bottom. A confectionery topping such as raspberry, strawberry, pineapple and the like are placed at the bottom of the receptacle and on top of that is placed ice cream, after which the cover is applied. At home, the cover is removed, the package is inverted and the movable cover pressed so that the ice cream is ejected. The topping is said to be released and “will flow over the ice cream forming an ice cream sundae.” The receptacle may be made of any suitable material such as waterproofed paper, cardboard or the like. The topping should have a sufficient amount of sugar to lower its freezing point to ensure that it will not freeze in the cold cabinet. Stover adds tartaric acid to convert sucrose to dextrose, which inverts. Acid is neutralized with bicarbonate of soda.

JP 08140583, according to a machine translation, relates to ice cream covered with chocolate using a container.

Green et al., WO 2006/056270 relates to an edible open-ended container for foodstuffs composed of cereals and/or fruits in a sheet. On page 1, Green et al. mention that edible containers obtained by means of cooking a batter lose their crispiness over time by absorbing moisture which softens them and that the solution is to coat the inner surface of the container with a fat based coating, for example, chocolate. The inner surface of the Green et al. container is non-porous such that it allows a homogeneous coating, for example with a confectionery fat, for example a chocolate, a vegetable fat or compound to form a moisture barrier and thus retaining a desirable crispiness. The batter from which the container is made may include fat.

Green et al. indicate that their containers typically have a low fat content normally from 3 to 5% but which in some cases can be up to 10%. The main function of the fat is said to be as an anti-sticking/releasing agent. The containers may have a variety of shapes or sizes, such as cone shaped, cup shaped or tubular. The container of the Green et al. invention may be used in a variety of confectionery products together with confectionery material such as ice cream, chocolates, and other fatty material such as fat based creams. To avoid the phenomenon wherein because of high water activity of the filling moisture passes into the container and the container loses its crispiness, the edible container needs to be coated in the case of a high moisture content filling with a fat based coating such as chocolate, vegetable fat or compound coating, for example. The batters can contain fats such as coconut fat. In Example 1 the cone shaped cake is coated on the inside with a plain chocolate layer which serves as moisture barrier, filled with vanilla ice cream and topped with chocolate chips.

GB 1586461 discloses a packaged frozen confectionery product comprising a plurality of ice confectionery articles having a fat based coating and each being two to eight cc in volume, contained in a thermoformed packaging tray having cavities conforming in shape to the shape of the articles therein, the articles having been molded in the cavities. The ice confectionery articles are composite having a fatty coating, for example, chocolate which may be a thin shell-like covering fully enclosing the ice confection. Use of a thermoformed tray for the ice confection is said to be particularly suitable since when the ice confection is in the frozen state, and particularly if It is chocolate coated, it is said to be very readily ejected from the mold cavity.

GB 1050213 is directed to a frozen confection adapted to be mixed with an aqueous liquid to produce a beverage capable of melting and of producing carbonation so as to form, e g. an Ice cream soda. In FIG. 4, a container having a closed, movable bottom end, a block of ice cream centrally disposed in the container, syrup between the ice cream and side walls of the container, carbonated ice above the ice cream and a removable cover are illustrated. In FIG. 5 the container is inverted and the syrup, ice cream and carbonated ice leave the container and enter a receptacle. The frozen confection may be packed in any suitable, conveniently size container fabricated from paper, plastic, glass, metal or the like.

Daousc et al., U.S. Pat. No. 5,843,512 is directed to a confectionery article which is prepared from a shell of chocolate. A frozen confection may be deposited into the shell's hollow space. Also a biscuit coated by a fatty composition may be deposited within the shell with the frozen confection and consequently enrobed to provide a base integral with the shell. The wafer is protected from moisture by a coating of fatty composition, notably of chocolate or fat coating so that it can be in contact with the frozen composition without risk of drawing on its moisture and becoming soft.

Talbot, WO 2006/094575 is directed to a spinning device on which particulates or liquid coating materials are loaded, which is placed adjacent an inner surface of an edible shell or support, and the spindle and applicator device are spun at a rotational speed sufficient to dispense the particulates or liquid materials out of the applicator device against the inner surface of the shell or support. The particulates may comprise ground nuts, cereal, crisped rice, cookie fines, candy pieces, chocolate chips, confectionery, sprinkles, compound chips or chunks, fruit pieces, coconut or combinations thereof, while the liquid coating material may be a liquid chocolate, liquid caramel, a fat based coating material, a sugar based edible coating material or a combination thereof.

The shell may be cone shaped although various shapes may be used including bowls, cups, balls, cylinders, pyramids, etc. Ice cream or other frozen confectionery filling materials may fill the shell. Possible liquid coating materials include nougat, marshmallow, caramel and fudge. Coating materials may contain cocoa butter, coconut oil and other ingredients. If desired, a second layer of the same or different shell forming material may be applied over the particulate inclusions.

Any material may be used as the-liquid coating material, as long as it solidifies at room temperature, or when frozen if intended for frozen confectionery products. Thus any of a wide variety of materials, including real chocolate, lower fat or high fat compound coating materials, and sugar based materials as well as coating materials made with non-sugar sweetener, starch, fiber or protein may be utilized. In addition to chocolate or fat based shells, the Talbot method is said to be used to apply particulate inclusions on shell forming materials comprising melted nougat or marshmallow cream, caramel, fudge, high boiled sugar, gelatin, pectin based jelly, dried honey, Turkish delight or any other edible material to which particulates can adhere or any combination thereof.

Where the Talbot filling to be added to the shell is an ice confection such as ice cream, the particulates may be pre-coated or pre-treated to provide a moisture barrier such that they are more resistant to moisture uptake even when they come in contact with the ice confectionery filling, to inhibit or prevent moisture migration into moisture sensitive inclusions. The shells may be chocolate or fat based. The shell forming materials may comprise caramel, fudge, high boiled sugar or any other edible material to which particulates can adhere, or any combination thereof. The shell may be formed on a mold or a packaging support. To produce an edible shell with decorative patterns on its outer surface, a liquid coating material may be applied to the inner surface of a mold or packaging support after which a chocolate shell forming composition is dispensed into the mold.

Cebula et al., WO 94/07375 is a member of the same patent family as Canadian Patent No. 2,146,148. The '148 patent is directed to production of fat-containing products, e.g. chocolate products. In which a molten fat containing mass is introduced into a mold. The mold has a temperature at or below 0° C. In Example 1 chocolate is used. In Example 3, the mold is fabricated from polycarbonate. In Example 11 a couverture containing 46% fat (cocoa butter, dairy fat and coconut oil) instead of chocolate was used. A frozen confection can be placed in the chocolate shell made by the process of the Cebula et al. invention. The chocolate shells were found to de-mold readily in the process of Cebula et al.

Ison et al., EP 948899 is directed to a shelled confectionery product, e.g. a chocolate shell biscuit which is contained in a self-supporting receptacle. The receptacle, which forms the packaging of the product, is suitably formed from a thermoformable plastic material.

JP 08214784 is directed to a frozen dessert material which includes chocolate and a mold.

Moreau, CH 379249 is directed to molds which may be plastic and are filled with liquid chocolate. The molds are superficially cooled to form a solid coating on the molds and the remaining liquid chocolate is removed by reversing the molds. The coated molds are filled with ice cream and then cooled, after which the coated ice cream bouchees are removed from the molds by turning the molds upside down.

### SUMMARY OF THE INVENTION

The present invention is directed to the discovery of a frozen confection sundae which is prepackaged and wherein the sundae may be released from its container cleanly or with minimal amounts of topping adhering to the container.

The product is an ice cream sundae or other frozen confection sundae in a cup. Since the cup is intended to be inverted before serving, the sauce topping for the sundae, such as chocolate fudge, butterscotch or caramel is disposed toward the bottom of the container, beneath the frozen confection. To prepare the sundae for consumption, the cover is removed, the product may, if desired, be warmed in the hand, the cup inverted and the sundae is ejected by exerting pressure from the inverted bottom end of the cup.

In accordance with the invention, a release agent is interposed between the sauce topping and the container. It has been found that use of a coating release agent permits a very clean release of the chocolate fudge or other topping from the sides and bottom of the container, with the result of a more aesthetically pleasing and natural looking ice cream sundae with minimal or no loss of topping to the sides and/or bottom of the container.

Use of the present invention avoids the need to put extra topping onto the confection before or after it has been removed from the container to replace topping which has been, or will be, lost due to adhesion to the container. This is particularly advantageous when the product is used in restaurants.

Preferably, the release agent is a chocolate confection coating such as chocolate confection coating of the type used to coat the insides of ice cream cones.

Desirably the container is made of paperboard, but it could also be made of thermoplastic, glass, metal or other material. Preferably, it is inedible.

The bottom panel of the container may include an aperture, more preferred a perforation for forming an aperture, so that the person removing the sundae from the container merely places her or her finger through the aperture and against a movable support thereby pushing the product out of the container. Alternatively, the bottom panel may include lines of weakness which may form the aperture upon exertion of pressure by the person opening the container. Or, the bottom panel may be movable within the sidewalls of the container. Another alternative is to eject the frozen confection simply by squeezing the sidewalls of the inverted cup.

Hand warming is not necessary with the present design wherein the bottom panel includes a perforated aperture and wherein a movable support or insert is used.

Typically, the container will include a first end which has a floor panel, and a second end opposite the first end and which is open or has a removable cover. Between the first and second ends will be at least one side wall. Generally, the side wall will be circular, although it may be oval or there may be multiple side walls such as in the case where the container is rectangular in cross section. The side walls may be tapered inwardly and downwardly or may be non-tapered, as desired. If made from plastic, injection molding would be a preferred method of fabrication of the container.

The release agent preferably forms a rigid layer (preferably 0.1 mm or thicker) when the finished product is frozen. The coating release agent will not adhere to a paperboard insert, but will adhere to “fudge-like” sauce which will be on the top surface of the “sundae-like ice cream” portion of the frozen dessert. Use of coating release agent of the invention permits use of a large amount of topping, e.g., 10% or more by total weight, especially 12-20% by weight, preferably 14-18% by weight. The topping is preferably at least 1.5 mm thick, especially from 2-4 mm thick. This is in contrast with the thin fudge layer found in at least one prior product.

While not wanting to be limited by theory, it is believed that the difficulties encountered with the adhesion of sundae topping to containers stems from the stickiness of the topping, which in turn, is caused largely by high sugar content. The presence of the release agent in accordance with the invention, ameliorates the effects of the high sugar content of the toppings.

For a more complete understanding of the above and other features and advantages of the invention, reference should be made to the following detailed description of the invention and to the accompanying drawings.

### BRIEF DESCRIPTION OF THE DRAWINGS

FIG. 1 is a perspective view showing a container useful in the invention in the form of a cup having a movable bottom insert.

FIG. 2 is a perspective view of a transparent cup showing release agent coated therein.

FIG. 3 is a top plan view of the cup of FIG. 2.

FIG. 4 is a perspective view of a transparent cup of an alternative embodiment.

FIG. 5 is a front elevational view of a transparent cup.

FIG. 6 is a perspective view of a sundae having been released from the cup and resting on a plate.

FIG. 7 is a top plan view of the sundae and plate of FIG. 7.

### DETAILED DESCRIPTION OF THE INVENTION

The foodstuffs used in the invention are those generally known as ice cream sundaes. Ice cream sundaes comprise at least two components, a frozen confection such as an ice cream and a sauce-like confectionery topping.

The frozen confection used in the invention is preferably ice cream, but any frozen confection which is not completely fluid at room temperature may be used. Thus, in addition to ice cream, other frozen confections which may be used include frozen yogurt, ice milk, sherbets, sorbets, etc. Classifications are given for ice cream and other suitable frozen confections in Marshall and Arbuckle, “Ice Cream,” 5^{th} Ed., 1996, Chapman & Hall, New York, N.Y., the disclosure which is hereby incorporated by reference herein.

Frozen confections herein are not flowable at room temperature; so frozen confections do not for the purposes of the present invention include thin milkshakes. Although many frozen confections will melt with time at room temperature, they are suitable herein so long as they retain their shape at room temperature for at least a short period of time.

In addition to the frozen confection, the sundae comprises a topping in the form of a sauce. Typically, confectionery sauces have relatively high sugar levels.

The composition of the sauce preferably is within the following parameters:

| | |
|---|---|
| Range of Brix | 40-80, preferably from 60-70 |
| Range of Dry Matter | 10%-80%, preferably 60%-70% |
| Range of Water | 15%-70%, preferably 20%-40% |
| Range of Total Fat | 5%-30%, preferably 10%-15% |

The viscosity of the sauce preferably ranges from 2,500-250,000 centipoise, especially 25,000-40,000 centipoise.

The sauce used as a topping for the frozen confection may be any one suitable for coating frozen confections such as one or more of the following and including any combination thereof: Chocolate Fudge, Caramel, Butterscotch, Marshmallow, Fruit Preps, Chocolate Syrups, Peanut or other Nut Butter with or without sugar or other added ingredients and Fat Based Variegates.

As indicated above, the sauce should have a viscosity of 25000-40000 cps). A typical sauce product (low viscosity fudge) can be purchased at Masterson Company, Inc. in Milwaukee, Wis.

In accordance with the invention, a release agent is interposed between at least part of the sauce and at least one of the floor and sidewalls of the container. The release agent may be coated directly on a floor panel (stationary or movable) or it may be coated on an insert, preferably one which is movable.

While not wanting to be bound by theory, it is believed that the presence of hydrogenated fats in the release agent promotes release of the paperboard or other container wall from the sticky surfaces of the fudge or other confectionery sauce topping.

Preferably, the release agents of the invention are coatings which include the following ranges of components:
Range of Total Sugars—75% or less, preferably 5-75%, especially 35-50%
Range of Water—0-3%, especially 1% or less
Range of Total Fat—10-65%, especially 30-50%
Range of Saturated Fat—0.5-60%, especially 25-45%

As will be appreciated given the nature of the coating, it will be somewhat viscous. Preferably, its viscosity will be within the range of Range from 10-25 mPas.

Coating Release Product ingredients may include:
Saturated Fats including but not limited to Coconut, Palm Oil and Palm Kernel Oil
Butterfat, Butter oil, or Anhydrous Butterfat or Milkfat
Saturated Animal Fats including but not limited to Lard
Hydrogenated Oils including, but not limited to Canola, Soy, Corn, Safflower, Sunflower
Partially Hydrogenated including, but not limited to Canola, Soy, Corn, Safflower, Sunflower
Compound Chocolate including but not limited to Dark, Milk or “White” varieties
Pure Chocolate including but not limited to Dark, Milk or “White”
Pure Chocolate including but not limited to Dark, Milk or “White”+Coconut, Palm, and/or Palm Kernel Oils
Pure Chocolate including but not limited to Dark, Milk or “White”+no more than 10% commercially available non-saturated Oils including, but not limited to Soy, Canola, Safflower, Sunflower
Fat Based Variegates
Nut Butters with or without added sugar

The release agent may be dosed directly onto the bottom of the interior of the cup or onto an insert placed atop the interior bottom panel of cup. Preferably, the coating is also dosed onto at least a portion of the interior of the one or more side walls of the container.

The release agent preferably forms a rigid layer (0.1 mm or thicker) when the finished product is frozen. The release agent will not adhere to a paperboard insert, but will adhere to “fudge-like” sauce which will be on the top surface of the “sundae-like ice cream” portion of the frozen dessert.

The Coating Release Product is applied as a liquid at temperatures between 40° F. and 150° F.

A suitable release agent is Coating Chocolate IC 2833 available for sale from ADM (Archer Daniels Midland) of Milwaukee, Wis.

As an example, fudge-like sauce product is preferably dosed on top of the release agent when constructing the product in the inverted cup. The reason this step is important is that the fudge-like product is typically quite sticky. Without the coating release agent this fudge-like product would stick to the container, thus impeding the release of the “Sundae-like” ice cream product onto a plate. The present product is believed to be different from other “sundae-like” products in a cup because it is removed easily onto a plate, at which time the fudge-like product begins to drip down the sides of the ice cream, thus simulating a typical fudge sundae made in an ice cream parlor or scoop shop or in a home setting. The coating release product permits the maximum quantity of Fudge-like product to remain on top of the ice cream when the entire container is released onto a plate.

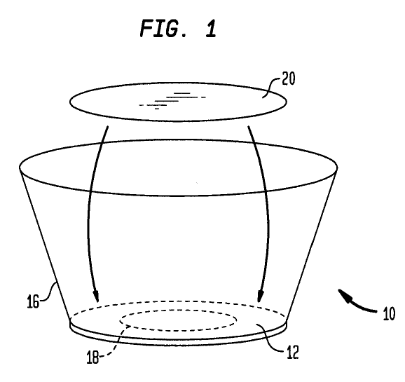

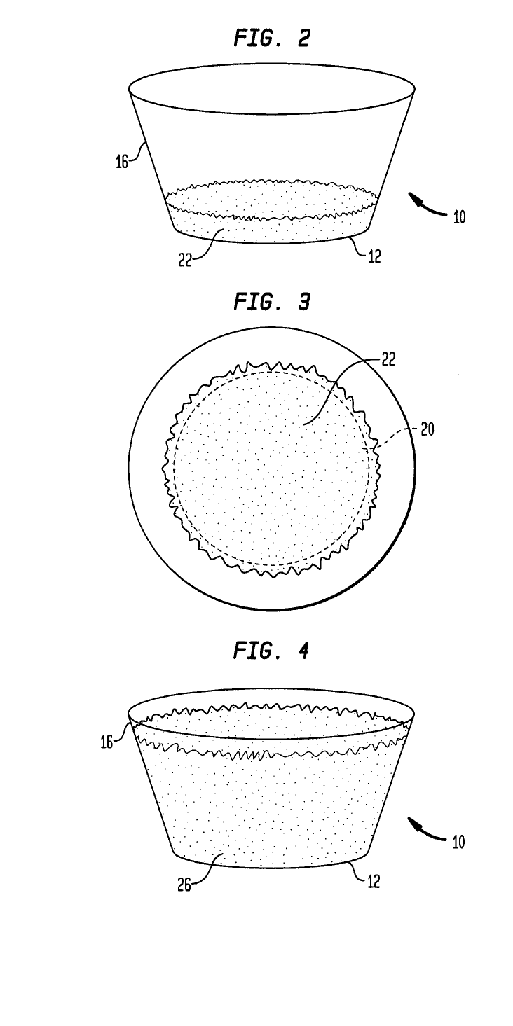

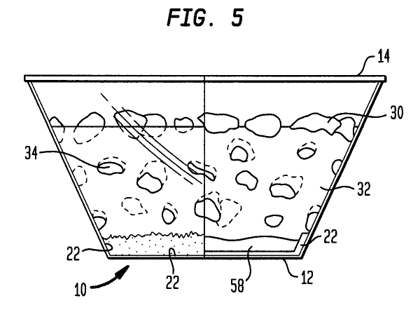

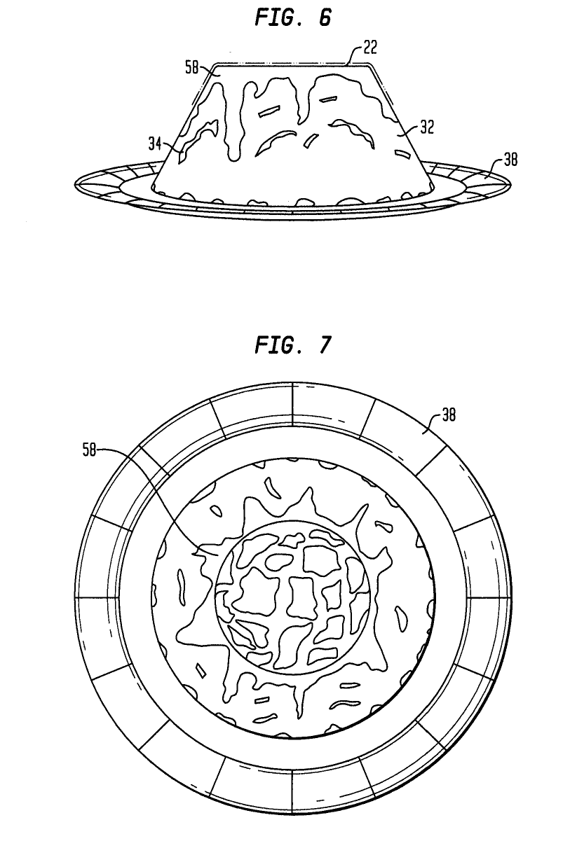

As seen in FIGS. 1 and 5, cup 10 includes bottom panel 12 and removable lid 14 at the opposite end thereof. It is fabricated from paperboard. Disposed between panel 12 and lid 14 is sidewall 16. Bottom panel 12 includes aperture 18. Paperboard insert 20 is dimensioned to fit atop of bottom panel 12. As seen in FIGS. 2 and 3, chocolate confection coating 22 is sprayed onto insert 20 and 10 mm up sidewall 16 of cup 10.

Alternatively, as seen in FIG. 4, the release agent can be applied, e.g., sprayed or coated, to cover much of the interior of the cup along the interior of sidewall 16 in addition to bottom panel 12 or bottom insert 20.

After the release agent has been coated on the cup, sauce 58 is placed in the bottom end of the cup above the release agent coating 22. Then, frozen confection 32 which may include particulates 30 such as brownie or cookie bits and variegates 34, is placed in the cup atop the sauce 58.

In one embodiment, the steps of serving the product involve the following:

Flipping a product of the invention onto a plate or bowl by the steps of:
Pull the heat seal or fitted lid off of the cup
Turn the cup upside down onto a plate
Hold the cup from the side with one hand
Put finger or thumb of the other hand onto the portion of the bottom formed within the perforations perforated in the original bottom of the cup
While still holding with the one hand push down with finger or thumb of the second hand on the area within the perforations in bottom of container
The ice cream sundae will start to move down onto the plate
When this happens the first hand can lift the cup off of the ice cream product
On top of the ice cream product will remain a paper board insert
With a thumb and finger grab an edge at any place on the insert and peel the paper board insert off the top of the ice cream product
Product of the invention maintains a uniform, conical shape of ice cream sitting on top of a layer of brownies or cookies with a chocolate fudge sauce on top
Within a minute the viscous sauce on the top of the ice cream will start running down the sides of the ice cream thus resembling the appearance of a typical hot fudge sundae

In an alternative embodiment, no opening is present in the bottom of the container. In such containers the product is dispensed as follows:
Pull the heat seal or fitted lid off of the cup
With the cup in an upright position use one or two hands to give the cup a series of gentle squeezes all around the cup
Turn the cup upside down onto a plate
While still holding the cup with the one hand push down with fingers or thumb of the second hand on the bottom of the cup
The product on the inside of the cup will release from the cup and begin to fall onto the plate below
When this happens, the cup can be pulled off of the ice cream product
On top of the ice cream product will remain the paper board insert
With a thumb and finger grab an edge at any place on the insert and peel the paper board insert off the top of the ice cream product
Within minutes the variegate sauce on the top of the ice cream product will now start running down the sides of the ice cream thus resembling the appearance of a typical hot fudge sundae

In a further alternative embodiment wherein the container includes no insert and no bottom panel aperture, the product is dispensed as follows:
Pull the heat seal or fitted lid off of the cup
With the cup in an upright position use one or two hands to give the cup a couple of gentle squeezes all around the cup
Turn the cup upside down onto a plate
While still holding the cup with the one hand push down with fingers or thumb of the second hand on the bottom of the cup
The product on the inside of the cup will release from the cup and begin to fall onto the plate below
When this happens, the cup can be pulled off of the ice cream product
There is no paper board insert in this design
Within minutes the variegate sauce on the top of the ice cream product will now start running down the sides of the ice cream thus resembling the appearance of a typical hot fudge sundae

The many advantages of the invention will be apparent.

Chocolate confection coating release or other release agent, prevents the fudge used in the frozen confection from sticking to the bottom of the cup It permits the entire Contents of the pre-packaged Ice cream sundae to be removed from the container without damaging/distorting the shape of the sundae. Preferably, the entire interior of the cup/container is sprayed with a thin coating of chocolate confection coating release or other release agent, whereby the fudge does not adhere to the bottom of the cup. Use of the release agent permits placing a copious amount of fudge or other topping sauce in the sundae container.

The product of the invention is preferably made according to the following steps:

Manufacturing the Product of the Invention
Stage #1—Add insert to cup with hole in the base (or perforations defining future hole)
Stage #2—Cup drops into carriage
Stage #3—Chocolate Confection Coating Release is sprayed onto bottom and/or sides of the interior of the cup
Stage #4—A fudge-like variegate sauce is added to the cup
Stage #5—Ice Cream with particulate add-ins and/or variegate sauce is filled into the cup
Stage #6—Small ¼″ to ½″ particulate add-ins are dropped onto the ice cream stage
Stage #7—Potentially a tempering device would flatten the particulate add-ins in Stage #5 down into the ice cream
Stage #8—A heat sealed lid or fitted lid is now adhered/put onto the cup

If an insert is used and is sprayed with the chocolate confection coating release, the ice cream sundae releases intact. Then the insert is removed leaving the chocolate confection coating release on top of the sundae. The chocolate confection coating release forms a thin layer of chocolate on top of the variegate layer of the sundae. As the variegate begins to flow down the sides of the ice cream the chocolate confection coating release agent breaks apart and begins to flow.

If the entire Interior of the cup/container used for the Flipped Out is sprayed with a thin coating of chocolate confection coating release, not only does the fudge not adhere to the bottom of the cup, but the chocolate confection coating release agent between the ice cream and the sides of the cup sticks to the cup. This allows the ice cream to release quickly and it leaves the sides of the ice cream uncovered with chocolate confection coating release. In other words, the appearance is that of a typical ice cream sundae with bare ice cream topped by a variegate.

It should be understood of course that specific forms of the invention herein illustrated and described are intended to be representative only as certain changes may be made therein without departing from the clear teachings of the disclosure. Accordingly, reference should be made to the following appended claims in determining the full scope of the invention.

What is claimed is:

1. A combined frozen confection and container comprising
a container including a first end having a floor panel, a second end opposite said first end and which is open or has a removable cover and at least one side wall between said first and second ends, a frozen confection having a sauce disposed thereon contained within said container and a release agent interposed between at least part of said sauce and at least one of said floor and said side wall.

2. The combined frozen confection and container according to claim 1 wherein said container is a cup.

3. The combined frozen confection and container according to claim 1 wherein said floor includes an aperture 5 millimeters in diameter or longer.

4. The combined frozen confection and container according to claim 3 wherein the aperture is 10 millimeters in diameter or longer.

5. The combined frozen confection and container according to claim 1 further comprising a movable support interposed between said floor and said frozen confection and wherein said release agent is interposed between said frozen confection and said movable support.

6. The combined frozen confection and container according to claim 1 wherein said container is made of paperboard.

7. The combined frozen confection and container according to claim 1 wherein said container is made of thermoplastic.

8. The combined frozen confection and container according to claim 1 wherein said side wall is generally circular.

9. The combined frozen confection and container according to claim 1 wherein said side wall is generally oval.

10. The combined frozen confection and container according to claim 1 wherein said aperture is generally circular.

11. The combined frozen confection and container according to claim 1 wherein said sauce is a fudge sauce.

12. The combined frozen confection and container according to claim 1 wherein said sauce is a butterscotch sauce.

13. The combined frozen confection and container according to claim 1 wherein the sauce is a caramel sauce.

14. The combined frozen confection and container according to claim 1 wherein the release agent is sprayed on at least part of one of said sauce, said floor and said side wall.

15. The combined frozen confection and container according to claim 1 wherein the release agent is a chocolate confection coating.

16. The combined frozen confection and container according to claim 1 wherein 90% or more of the inner surface of the side wall is coated with the release agent.

17. The combined frozen confection and container according to claim 16 wherein 90% or more of the inner surface of the bottom panel is coated with the release agent.

18. The combined frozen confection and container according to claim 16 wherein 90% or more of the inner surface of the movable support is coated with the release agent.

19. The combined frozen confection and container according to claim 1 wherein the release agent includes 75 wt % or less total sugars from 0-3 wt % water, 10-65 wt % total fat, and 0.5-60% saturated fat.

20. The combined frozen confection and container according to claim 19 wherein the release agent includes 5-75 wt % total Sugars, 0.25-3 wt % water, 30-50 wt % total fat and 2545 wt % saturated fat.

21. The combined frozen confection and container according to claim 20 wherein the release agent includes 35-50 wt % total sugars and 0.5-1 wt % water.

22. The combined frozen confection and container according to claim 1 wherein the release agent includes saturated fat sources selected from the group of Coconut oil, Palm Oil, Palm Kernel Oil, Butterfat, Butter oil, anhydrous butterfat, Milkfat, Saturated Animal Fats, Lard, Hydrogenated Oils and partially hydrogenated oils.

23. The combined frozen confection and container according to claim 22 wherein the hydrogenated oils are selected from the group of Canola, Soy, Corn, Safflower and Sunflower oils,

24. The combined frozen confection and container according to claim 22 wherein the partially hydrogenated oils are selected from the group of canola, Soy, Corn, Safflower and Sunflower oils.

25. The combined frozen confection and container according to claim 1 wherein the release agent is selected from the group of Compound Chocolate, Pure Chocolate, Fat Based Variegates and Nut Butters.

26. The combined frozen confection and container according to claim 25 wherein the compound chocolate is selected from the group of Dark, Milk and White varieties.

27. The combined frozen confection and container according to claim 25. where the Pure Chocolate is selected from the group of Dark, Milk or White chocolates and Dark, Milk or White chocolates incorporating one or more of Coconut, Palm, and/or Palm Kernel Oils, and Dark, Milk or White varieties incorporating no more than 10% commercially available non-saturated Oils.

28. The combined frozen confection and container according to claim 27 wherein the non-saturated oils are selected from the group of Soy, Canola, Safflower and Sunflower oils.

29. The combined frozen confection and container according to claim 1 wherein the composition of the sauce is within the following parameters:

| | |
|---|---|
| Range of Brix | 40-80, |
| Range of Dry Matter | 10%-80 wt %, |
| Range of Water | 15%-70 wt %, |
| Range of Total Fat | 5%-30 wt %, |

viscosity from 2,500-250,000 centipoise.

30. The combined frozen confection and container according to claim 1 wherein the composition of the sauce is within the following parameters:

| | |
|---|---|
| Range of Brix | 60-70 |
| Range of Dry Matter | 60%-70 wt % |
| Range of Water | 20%-40 wt % |
| Range of Total Fat | 10%-15 wt % |

viscosity 25,000-40,000 centipoise.

31. The combined frozen confection and container according to claim 1 wherein said container is made of glass.

32. The combined frozen confection and container according to claim 1 wherein said container is made inedible.
